(19) United States
(12) Patent Application Publication
(10) Pub. No.: US 2021/0004616 A1
(43) Pub. Date: Jan. 7, 2021

(54) IMAGE-PROCESSING DEVICE, IMAGE-PROCESSING METHOD, AND STORAGE MEDIUM

(71) Applicant: NEC CORPORATION, Tokyo (JP)

(72) Inventor: Kazuki INAGAKI, Tokyo (JP)

(73) Assignee: NEC CORPORATION, Tokyo (JP)

(21) Appl. No.: 16/976,799

(22) PCT Filed: Feb. 27, 2019
(86) PCT No.: PCT/JP2019/007644

§ 371 Date: Aug. 31, 2020

(30) Foreign Application Priority Data
Mar. 2, 2018 (JP) 2018-038078

(51) Int. Cl. G06K 9/00; H04N 7/18

(52) U.S. Cl. CPC G06K 9/00832; G06K 9/00255; H04N 7/183

(57) ABSTRACT

An image processing device includes: a determination unit that determines whether a moving body driven by a driver is moving forward, based on acquired information, and determines that imaging timing is in a satisfactory state when it is determined that the moving body is moving forward.

### TECHNICAL FIELD

The present invention relates to an image processing device, an image processing method, and a storage medium.

### BACKGROUND ART

In recent years, drive recorders that record the driving states of drivers have been widely used. Some drive recorders can capture images of the driver's face.

Patent Document 1 discloses a technique for acquiring a clear facial image of a driver.

### PRIOR ART DOCUMENTS

### Patent Documents

[Patent Document 1] Japanese Patent Publication No. 6052062

### SUMMARY OF THE INVENTION

### Problem to be Solved by the Invention

The above-mentioned technology describes the facial image of the driver being captured by a vehicle-mounted camera when the steering angle of the steering wheel is within a predetermined range including the straight-ahead direction of the vehicle. However, even when the steering angle of the steering wheel indicates a straight-ahead direction, the driver often drives the vehicle while visually observing the surroundings during low speeds immediately after the start of driving, and so the possibility remains of the frontal facial image of the driver not being appropriately acquirable. Therefore, there is a demand for a technique that can more appropriately acquire the frontal facial image of the driver.

An example object of the present invention is to provide an image processing device, an image processing method, and a storage medium that solve the above problems.

### Means for Solving the Problem

According to a first example aspect of the present invention, an image processing device includes a determination unit that determines whether a moving body driven by a driver is moving forward, based on acquired information, and determines that imaging timing is in a satisfactory state when it is determined that the moving body is moving forward.

According to a second example aspect of the present invention, an image processing method includes: determining whether a moving body driven by a driver is moving forward, based on acquired information; and determining that imaging timing is in a satisfactory state when it is determined that the driver is moving forward.

According to a third example aspect of the present invention, a storage medium stores a program for causing a computer to execute: determining whether a moving body driven by a driver is moving forward, based on acquired information; and determining that imaging timing is in a satisfactory state when it is determined that the driver is moving forward.

### Effect of the Invention

According to an example embodiment of the present invention, it is possible to more appropriately acquire a frontal facial image of the driver.

### BRIEF DESCRIPTION OF THE DRAWINGS

FIG. 1 is a diagram showing the outer appearance of a driving state monitoring system according to an example embodiment of the present invention.

FIG. 2 is a diagram showing the configuration of the driving state monitoring system according to the example embodiment of the present invention.

FIG. 3 is a hardware configuration diagram of an image processing device according to the example embodiment of the present invention.

FIG. 4 is a function block diagram of the image processing device according to the example embodiment of the present invention.

FIG. 5 is a drawing showing a hardware configuration of a drive recorder according to the example embodiment of the present invention.

FIG. 6 is a diagram showing the processing flow of the driving state monitoring system according to the example embodiment of the present invention.

FIG. 7 is a diagram showing a configuration of an image processing device according to another example embodiment of the present invention.

### EXAMPLE EMBODIMENTS FOR CARRYING OUT THE INVENTION

Hereinbelow, a driving state monitoring system according to an example embodiment of the present invention will be described with reference to the drawings.

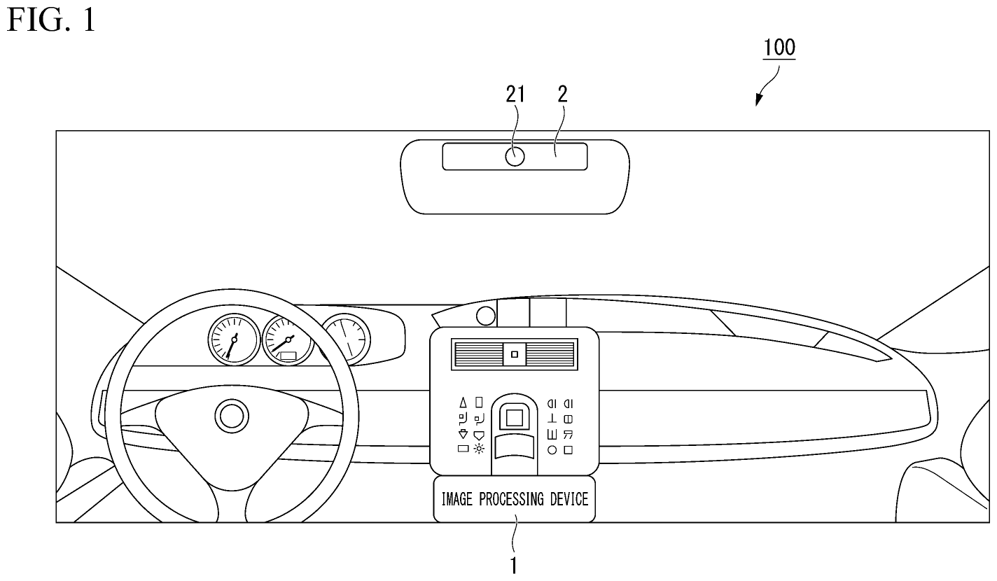

FIG. 1 is a diagram showing the appearance of the driving state monitoring system according to the example embodiment of the present invention.

The driving state monitoring system 100 is provided inside the vehicle (inside the frame that forms the outer contour of the vehicle) as an example. The inside of the vehicle may be an area surrounded by a frame forming an outer contour of the vehicle. The driving state monitoring system 100 is provided with an image processing device 1 and a drive recorder 2. The drive recorder 2 includes a vehicle inner camera 21 that captures an image of the inside of the vehicle. The drive recorder 2 may include a vehicle outer camera 20 that captures the straight-ahead direction outside the vehicle. The image processing device 1 may be provided in a car navigation system, which is one form of the vehicle-mounted device.

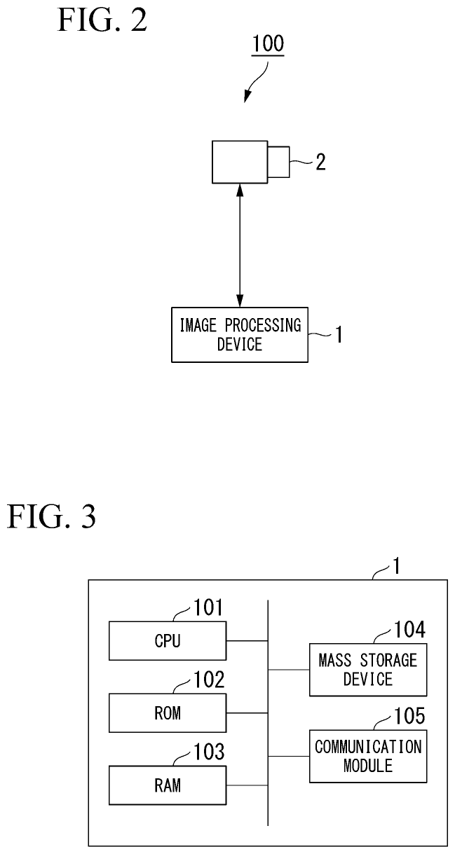

FIG. 2 is a diagram showing the configuration of the driving state monitoring system according to the example embodiment of the present invention.

As shown in FIG. 2, in the driving state monitoring system 100, the image processing device 1 and the drive recorder 2 are communicatively connected. The image processing device 1 and the drive recorder 2 may be connected via a wireless communication network or a wired communication network.

FIG. 3 is a hardware configuration diagram of the image processing device.

As shown in FIG. 3, the image processing device 1 includes a computer including hardware such as a CPU (Central Processing Unit) 101, a ROM (Read Only Memory) 102, a RAM (Random Access Memory) 103, a mass storage device 104, and a communication module 105.

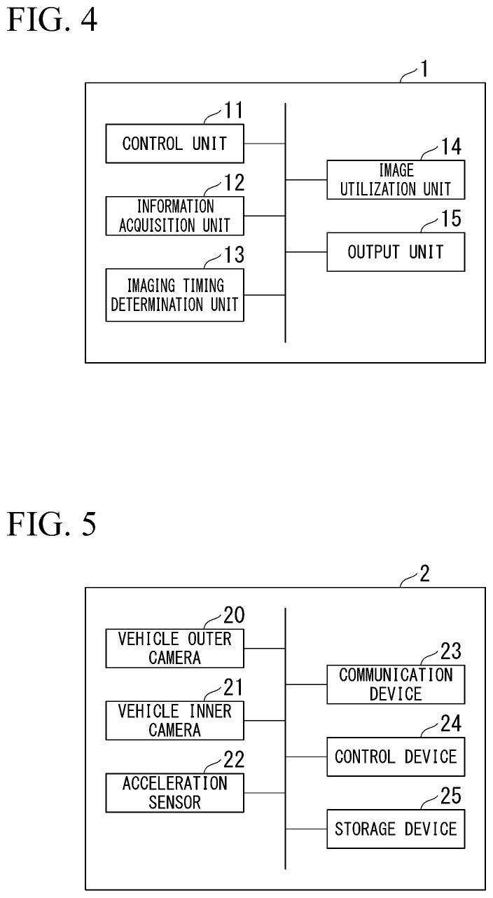

FIG. 4 is a function block diagram of the image processing device.

The image processing device 1 is activated when the power is turned on, and executes a driving state monitoring program stored in advance. As a result, the image processing device 1 can execute the functions of a control unit 11, an information acquisition unit 12, an imaging timing determination unit (determination unit) 13, an image utilization unit 14, and an output unit 15.

The control unit 11 controls the image processing device 1.

The information acquisition unit 12 acquires information used by the image processing device 1 for processing from another device or the like. The information acquired by the information acquisition unit 12 may be vehicle acceleration, vehicle speed, vehicle operation information, or information of a route which a vehicle travels.

The imaging timing determination unit 13 determines on the basis of the acquired information whether the moving body driven by a driver is moving forward. Upon having determined that the moving body is moving forward, the imaging timing determination unit 13 determines that imaging timing is in a satisfactory state. Upon having determined that the moving body is not moving forward, the imaging timing determination unit 13 determines that the imaging timing is not in a satisfactory state. The imaging timing being in a satisfactory state may mean there is a high possibility that the frontal face of the driver is included in the image of the driver captured by the drive recorder 2 at the imaging timing. The imaging timing being in a satisfactory state may mean there is a high possibility of the driver's face facing the direction in which the moving body is moving forward at the imaging timing. The imaging timing being in a satisfactory state may mean there is a high possibility that the frontal face of the driver is included in an image that captures a scene inside the vehicle in the direction opposite to the direction in which the moving body is moving forward at that imaging timing.

The image utilization unit 14 performs a predetermined process using the driver's facial image captured at a satisfactory state imaging timing.

The output unit 15 outputs or transmits facial images of the driver captured at the satisfactory state imaging timing to a predetermined device that performs processing using the facial images.

The imaging timing determination unit 13 may determine whether the vehicle is moving forward based on the acceleration of the vehicle driven by the driver. The imaging timing determination unit 13 may determine whether the vehicle is moving forward based on the speed of the vehicle driven by the driver. The imaging timing determination unit 13 may determine whether the vehicle is moving forward based on the operation information of the vehicle driven by the driver. The operation information includes the accelerator depression amount, the steering wheel steering angle, and the like. The imaging timing determination unit 13 may determine whether the vehicle is moving forward based on the information of a route which the vehicle drives by the driver. The route information may be information indicating a route that the vehicle is scheduled to follow to reach the destination. This example embodiment will be described using an example in which the moving body is a vehicle, but the example embodiment of the present invention is not limited to such a case. Any moving body may be used as long as the moving body is operated by the driver.

FIG. 5 is a diagram showing a hardware configuration of the drive recorder.

The drive recorder 2 includes a vehicle outer camera 20, the vehicle inner camera 21, an acceleration sensor 22, a communication device 23, a control device 24, a storage device 25, and the like. The vehicle outer camera 20 and the vehicle inner camera 21 perform imaging to generate moving images and still images. The acceleration sensor 22 detects the acceleration of the vehicle. The communication device 23 is communicatively connected to the image processing device 1.

The control device 24 controls each function of the drive recorder 2. The storage device 25 stores moving images, still images, acceleration detected by the acceleration sensor 22, other information acquired from the outside of the drive recorder 2, and the like. The control device 24 of the drive recorder 2 includes a computer including a CPU, ROM, RAM and the like.

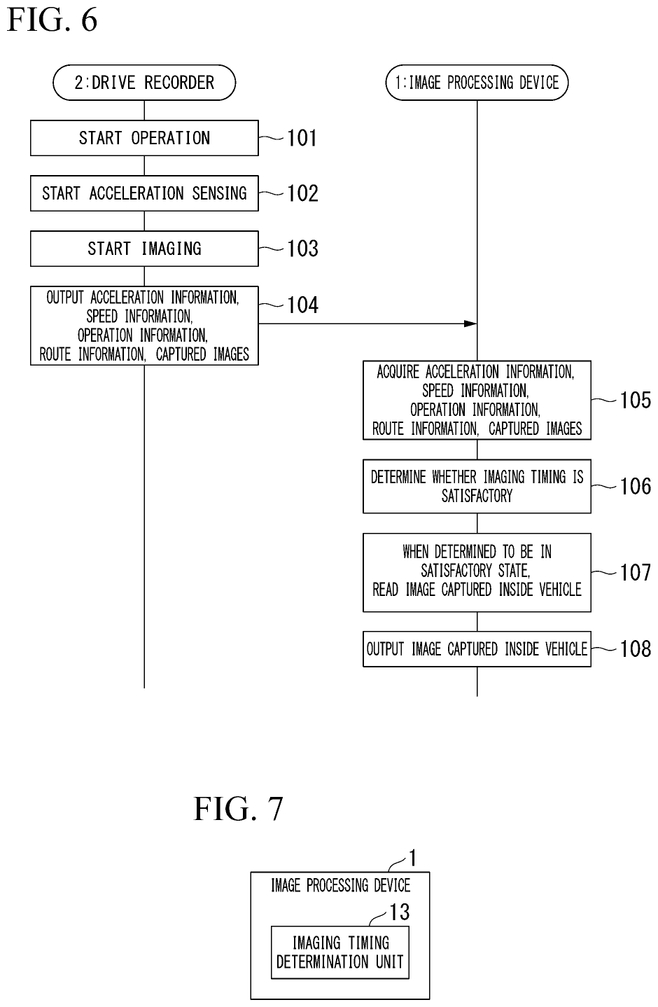

FIG. 6 is a diagram showing the processing flow of the driving state monitoring system.

Next, the processing flow of the driving state monitoring system will be explained step by step.

First, the processing in the drive recorder 2 will be described.

When the electrical system of the vehicle is activated, the drive recorder 2 starts operating (Step S101). The acceleration sensor 22 of the drive recorder 2 starts sensing the acceleration of the vehicle after the drive recorder 2 is started (Step S102). The acceleration sensor 22 records the acceleration information indicating acceleration along three axes in the storage device 25 at predetermined intervals. The three axes mean a straight-ahead direction, a vertical direction orthogonal to the straight-ahead direction, and a horizontal direction orthogonal to the straight-ahead direction and the vertical direction. Further, the vehicle outer camera 20 and the vehicle inner camera 21 start imaging (Step S103). The control device 24 acquires the vehicle speed information, the vehicle operation information, and the vehicle route information at predetermined intervals, and sequentially records the information in the storage device 25. The control device 24 can acquire the speed information from a speed detection sensor provided in the vehicle. The control device 24 can acquire the operation information from an operation detection sensor provided in the vehicle. The control device can acquire route information from a vehicle-mounted device such as a car navigation system or an external server device connected via a communication network.

The vehicle outer camera 20 captures images of an object in the traveling direction outside the vehicle (a scene to the front in the traveling direction) using a vehicle exterior lens, and records the captured images in the storage device 25 at predetermined intervals. The vehicle inner camera 21 captures images of an object in the direction toward the driver's face in the vehicle (a scene to the rear in the traveling direction (including the driver's face)) by using a vehicle interior lens, and records the captured images in the storage device 25 at predetermined intervals. During operation of the drive recorder 2, the control device 24 of the drive recorder 2 outputs the acceleration information, the speed information, the operation information, the route information, and the captured images recorded in the storage device 25 to the image processing device 1 (Step S104). The control device 24 may transmit at least one of acceleration information, speed information, and accelerator depression amount (an example of operation information). In the case of being used for determination of the imaging timing in the image processing device 1, the control device 24 may further transmit other operation information besides the accelerator depression amount and route information.

In the image processing device 1, the information acquisition unit 12 acquires information used for determination of imaging timing among at least one of the acceleration information, speed information, and accelerator depression amount, as well as operation information other than the accelerator depression amount and route information (Step S105). The information acquisition unit 12 sequentially records the acquired information in the mass storage device 104. Each time the imaging timing determination unit 13 acquires such information, the imaging timing determination unit 13 reads one or more of the acceleration information, the speed information, the operation information, and route information used for determination of the imaging timing. The imaging timing determination unit 13 uses the read information to determine whether the imaging timing is satisfactory (Step S106).

More specifically, the imaging timing determination unit 13 determines that the imaging timing is in a satisfactory state when a first state that the acceleration in the traveling direction is equal to or greater than a predetermined threshold is satisfied. The first state is a state indicating a situation in which a driver has a high probability of visually recognizing the straight-ahead direction (almost straight-ahead direction), such as a situation where the acceleration is sharply increased.

Further, the imaging timing determination unit 13 determines that the imaging timing is in a satisfactory state when a second state that the speed in the traveling direction is equal to or higher than a predetermined threshold is satisfied. The second state is a state indicating a situation in which a driver has a high probability of visually recognizing the straight-ahead direction (almost straight-ahead direction), such as a situation where the speed is high.

Further, the imaging timing determination unit 13 determines that the imaging timing is in a satisfactory state when a third state that the accelerator depression amount is equal to or greater than a predetermined threshold is satisfied, when the operation information is the accelerator depression amount. The third state is a state indicating a situation in which a driver with large acceleration or high speed has a high probability of visually recognizing a straight-ahead direction (almost straight-ahead direction).

In addition to determining whether the imaging timing is in a satisfactory state by using one or a plurality of the first state to the third state, the imaging timing determination unit 13 may determine whether the imaging timing is in a satisfactory state by using the following states.

For example, the imaging timing determination unit 13 may determine that the imaging timing is in a satisfactory state when a fourth state that the route information on which the vehicle is currently traveling is straight is further satisfied.

Further, the image capturing timing determination unit 13 may determine that the imaging timing is in a satisfactory state when a fifth state that the steering angle of the steering wheel is within a predetermined range based on (centered on) an angle in the straight-ahead direction is further satisfied. One or both of the fourth state and the fifth state may be further used. The steering angle of the steering wheel being within a predetermined range means an angle in the straight-ahead direction

Upon determining that the imaging timing is in a satisfactory state, the imaging timing determination unit 13 reads an image captured inside the vehicle, which was acquired at the imaging timing, from the mass storage device 104 (Step S107). The imaging timing determination unit 13 outputs the image captured inside the vehicle to the image utilization unit 14 (Step S108). The image utilization unit 14 uses the image captured inside the vehicle that was input for predetermined processing. For example, the image utilization unit 14 performs authentication processing of performing authentication using face information of the driver that appears in the image captured inside the vehicle, and identifying an identifier of the driver. The imaging timing determination unit 13 may output the image captured inside the vehicle that was read to the output unit 15. The output unit 15 may output the image captured inside the vehicle to a predetermined device. For example, the output unit 15 may transmit the image captured inside the vehicle to a remote cloud server connected via wireless communication. The cloud server may perform authentication processing using the image captured inside the vehicle. The image captured inside the vehicle may be an image captured by the vehicle inner camera 21.

When performing the authentication processing according to the above-described processing, the authentication processing can be performed using a captured image in which the driver's face is likely to be captured from the front. As a result, the above-described image processing device 1 and the device to which the image captured inside the vehicle is transmitted can suppress repetition of the authentication processing using a plurality of captured images and the re-transmission of captured images, thereby lessening the processing load.

Further, the image processing device 1 and the device that is the destination of the image captured inside the vehicle can acquire the captured image in which the frontal facial image of the driver appears with higher accuracy, the image being captured when the speed or acceleration was equal to or higher than a predetermined value.

FIG. 7 is a diagram showing an example of the configuration of the image processing device.

The image processing device 1 may include at least the imaging timing determination unit 13. The imaging timing determination unit 13 determines whether the moving body driven by the driver is moving forward based on the acquired information, and determines that the imaging timing is in a satisfactory state when the moving body is moving forward.

The image processing device 1 and the drive recorder 2 described above have a computer system inside. The process of each process described above is stored in a computer-readable recording medium in the form of a program, and the above process is performed by the computer reading and executing the program. Here, the computer-readable recording medium refers to a magnetic disk, a magneto-optical disk, a CD-ROM, a DVD-ROM, a semiconductor memory, or the like. Further, the computer program may be distributed to a computer via a communication line, and the computer that receives the distribution may execute the program.

Also, the above program may be for realizing some of the functions described above. Further, the program may be a so-called differential file (differential program) that can realize the functions described above in combination with a program already recorded in the computer system.

This application is based upon and claims the benefit of priority from Japanese Patent Application No. 2018-038078, filed Mar. 2, 2018, the disclosure of which is incorporated herein in its entirety.

### INDUSTRIAL APPLICABILITY

The present invention may be applied to an image processing device, an image processing method, and a storage medium.

### REFERENCE SYMBOLS

1: Image processing device
2: Drive recorder
11: Control unit
12: Information acquisition unit
13: Imaging timing determination unit
14: Image utilization unit
15: Output unit
21: Vehicle inner camera
22: Acceleration sensor
24: Control device

1. An image processing device comprising:
a memory configured to store instructions; and
a processor configured to execute the instructions to:
determine whether a moving body driven by a driver is moving forward, based on acquired information; and
determine that imaging timing is in a satisfactory state when it is determined that the moving body is moving forward.

2. The image processing device according to claim 1, wherein the acquired information comprises acceleration of the moving body.

3. The image processing device according to claim 1, wherein the acquired information comprises speed of the moving body.

4. The image processing device according to claim 1, wherein the acquired information comprises operation information that indicates an operation with respect to the moving body.

5. The image processing device according to claim 1, wherein the acquired information comprises the route information that indicates a route on which the moving body is moving.

6. The image processing device according to claim 1,
wherein the processor is configured to execute the instructions to perform a predetermined process by using a facial image of the driver captured at the satisfactory state imaging timing.

7. The image processing device according to claim 1, further comprising:
a transmitter that transmits a facial image of the driver captured at the satisfactory state imaging timing to a predetermined device that performs a process by using the facial image.

8. The image processing device according to claim 1, wherein the imaging timing being in the satisfactory state means that there is a high possibility that an image captured of the driver at the imaging timing includes a frontal face of the driver.

9. An image processing method comprising:
determining whether a moving body driven by a driver is moving forward, based on acquired information; and
determining that imaging timing is in a satisfactory state when it is determined that the moving body is moving forward.

10. A non-transitory computer-readable storage medium that stores a program for causing a computer to execute:
determining whether a moving body driven by a driver is moving forward, based on acquired information; and
determining that imaging timing is in a satisfactory state when it is determined that the moving body is moving forward.
